(19) United States
(12) Patent Application Publication
(10) Pub. No.: US 2010/0270288 A1
(43) Pub. Date: Oct. 28, 2010

(54) Device for heating food using induction and device for transmitting energy

(75) Inventors: Andreas Hackbarth, Munchen (DE); Uwe Has, Unterneukirchen (DE); Thomas Komma, Ottobrunn (DE); Dan Neumayer, Bernau (DE); Harald Pfersch, Freilassing (DE); Gerhard Schmidmayer, Bad Endorf (DE); Wolfgang Schnell, Trostberg (DE); Bernd Stitzl, Surberg (DE); Eckhard Wolfgang, Munchen (DE); Monika Zeraschi, Traunreut (DE); Felicitas Ziegler, Stein a.d. Traun (DE); Günter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/567,075

(22) PCT Filed: Jul. 15, 2004
(86) PCT No.: PCT/EP2004/007931

§ 371 Date: May 24, 2010

(30) Foreign Application Priority Data
Aug. 5, 2003 (DE) 103 36 117.0
Sep. 17, 2003 (DE) 103 43 011.3

(51) Int. Cl. H05B 6/12

(52) U.S. Cl. 219/624

(57) ABSTRACT

A device for heating food using induction, including a base element having a secondary winding configured from a current conductor and a heating element that is connected to the winding. To reduce the height of the base element, a winding core is located inside the winding. Further, a device for transmitting energy to a device for heating food by induction, the former device including a primary winding that is configured from a current conductor and is connected to a voltage source.

The invention relates to a device for heating food according to the preamble of claim 1 and a device for transmitting energy according to the preamble of claim 2.

Foods or components of food are heated in a device for heating food, for example, a pot, a pan, a grill, an oven or the like. For this purpose, the device has a base element into which heat is transferred or in which heat is generated. Such a device is known from U.S. Pat. No. 4,996,405 wherein a secondary winding formed from a current conductor and a heating element connected to the winding are arranged in a base element. The energy for the heating element is transferred from a primary winding disposed in a device for transmitting energy to the secondary winding by means of induction. This type of device has a relatively large volume so that this type of arrangement in a base element of a pot results in a pot having a large volume.

It is the object of the invention to further develop the generic devices and especially with regard to a small design.

The object directed towards the device for heating food is solved according to the invention by the features of claim 1 whilst advantageous embodiments and further developments of the invention can be deduced from the dependent claims 3 to 17. The object directed towards a device for transmitting energy is solved according to the invention by the features of claim 2 whilst advantageous embodiments and further developments of the invention can be deduced from the dependent claims 3 to 17.

The invention relates to a device for heating food by means of induction using a heating means comprising a secondary winding formed from a current conductor and a heating element connected to said winding.

It is proposed that a winding core is disposed inside the secondary winding. In this case, the invention starts from the consideration that good energy transfer from the primary winding to the secondary winding takes place if the magnetic flux generated by the primary winding flows as completely as possible through the secondary winding. For this purpose, the secondary winding should either be executed as large or the magnetic flux should be guided as precisely as possible. In order to achieve the smallest possible overall size, precise guidance of the magnetic flux through a winding core is advantageous, where the winding core is located inside the heating means and inside the winding. A high energy transfer can be achieved with a small design. The heating means can be a base element with which the device can be placed on a hob in an advantageous embodiment of the invention. Secondary winding is understood as a winding which is provided for the conversion of magnetic energy from a magnetic flux into electrical energy.

With regard to the device for transmitting energy, the invention relates to a device for transmitting energy into a device for heating food by means of induction, comprising a primary winding formed from a current conductor and connected to a voltage source. It is proposed that a winding core is disposed inside the primary winding. By analogy with that stated above, the magnetic flux generated by the primary winding can be largely guided and deflected to the primary winding. High powers can also be transmitted hereby with a small design. Primary winding is understood as a winding which is provided for producing a magnetic flux.

Good transmission of energy with a very small design of winding and winding core can be achieved if the winding core is configured as rotationally symmetrical. In addition, the inductive energy transfer in such an embodiment is independent of the angle of rotation of the device for heating food, for example, a pot, relative to the device for transmitting energy, for example an induction hob. The pot can be turned on the induction hob without influencing the inductive energy transfer. Since a high energy transfer density can be achieved with a rotationally symmetrical winding core, this embodiment is especially suitable for a small pot, for example, an expresso jug etc. With regard to an induction hob, this design is especially suitable for hobs provided for small pots.

The winding core is more appropriately configured as a pot core. A particularly high energy transfer density can be achieved with this type of winding core. Pot core is understood as an at least largely rotationally symmetrical core comprising an outer wall and an inner wall separated from the outer wall by a base. The inner wall can be configured as a column shape. It is also possible that the inner wall is configured as a wall surrounding a central recess, wherein this type of pot core is hereinafter designated as a ring core.

In an alternative embodiment of the invention, the winding core comprises a plurality of core elements. Especially if the induction hob or heating means has an extended surface area, it is expensive to manufacture a one-piece, large-area and relatively thin-walled winding core. Since sufficient space is available in the surface area here, an inexpensive winding core can be executed using a plurality of core elements whereby a high energy transfer and a very flat design of heating means or induction hob can be achieved.

The core elements are advantageously arranged on a circular path. In this way, any dependence of the induction energy transfer on the relative rotational position of induction hob and heating means with respect to one another can be largely avoided. In particular, the core elements are configured as circular-ring-segment-shaped. This dependence can hereby be reduced still further. Especially advantageous is the rotationally symmetrical arrangement of the primary or secondary winding core, for example, as a pot core, associated with an arrangement of a plurality of, core elements of the respectively other, that is secondary or primary winding core on a circular path. The dependence of the relative rotational position of the two devices from one another can be completely avoided in this way whereby the advantage of an inexpensive winding core can be associated with an especially dense energy transfer depending on the design. Thus, for example, there is sufficient space available within an induction hob to arrange a solid one-piece and rotationally symmetrical primary winding core which is relatively inexpensive to manufacture. Usually however, only a little height is available in the heating means or base element of the pot so a one-piece and very flat secondary winding core would be very sensitive and expensive to manufacture. A winding core comprising a plurality of core elements on a circular path can thus be arranged in the heating means of the pot.

Particularly good guidance of the magnetic flux can be achieved if the core elements are formed as U-shaped in one radial cross-section. In this case, the winding runs between the two legs of the U-shaped core elements which can in this way guide the magnetic flux around the winding.

Alternatively thereto, the core elements are formed as E-shaped in one radial cross-section. Particularly good guidance of the magnetic flux can also be achieved hereby. The core element comprises three webs arranged on a base located transverse to the radial direction, of which the central web is embraced by the winding and thus guides the magnetic flux centrally to the oppositely arranged winding core.

It is also suggested that the core elements are interconnected by a retaining means in a load-bearing manner. Easy assembly of the winding core in the induction hob or pot can be achieved where the core elements need not be positioned individually with respect to one another.

The retaining means is appropriately a printed circuit board. In addition to retaining and connecting the core elements in a load-bearing manner, contact of the winding with a heating element or a power source can be achieved by the printed circuit board.

A particularly simple arrangement of the core elements on a circular path can be achieved by the annular configuration of the retaining means.

It is furthermore proposed that the winding is arranged on a printed circuit board. In this way, the winding is executed as particularly stable and protected from damage and assembly of the winding can be facilitated. The winding can be arranged as a conductor path on or in the printed circuit board.

The winding can be arranged in a surface by means of a spiral arrangement of the winding and can be supported particularly simply by a flat supporting element such as a printed circuit board. The surface can be flat or curved.

Appropriately, the printed circuit board on which the winding is arranged is at the same time the retaining means which connects the core elements one to another in a load-bearing fashion. In this way, both the core elements and also the winding can be interconnected in a stable design and contact can be made particularly easily.

Particularly effective inductive energy transfer can be achieved if the heating means has a direction of greatest extension and the winding has an axis of rotation arranged perpendicular to this direction. The magnetic flux disposed inside the winding substantially parallel to the axis of rotation can in this way be guided directly out from the heating means and towards the induction hob for example. Curved flux lines in the core-free space can be largely avoided whereby particularly low-loss inductive energy transfer can be achieved.

In an advantageous embodiment of the invention the heating element has the same number of heating conductors as the winding core has core elements. A uniform load distribution of the heating elements can be achieved.

Appropriately, at least two heating conductors are arranged symmetrically with respect to one another and especially in a circular heating area. In addition to the same load distribution, a pot base, especially a round pot base can be uniformly heated. The symmetry can be a mirror symmetry so that the heating conductors are in a mirror-symmetrical arrangement with respect to one another. The symmetry can also be a point symmetry with a point of symmetry which appropriately lies at the centre of the heating area. A translation symmetry is also feasible where the heating elements are arranged translationally displaced with respect to one another.

Especially uniform heating of a pot base can be achieved if the heating conductors are arranged in a circular heating area and each heating conductor is arranged so that it is uniformly distributed in a piece-of-cake-shaped segment. The heating area has a certain thickness where the heating conductors can also project above and below from the surface.

In a preferred embodiment of the invention, the device for transmitting energy comprises an induction frequency generator which is provided to produce an induction frequency of over 80 kHz and especially between 80 kHz and 100 kHz. As a result of using a high induction frequency, a high transfer of induction energy can be achieved at the same time as a low voltage at the heating element and a small number of windings of the secondary winding. This has the advantage that the expenditure for insulating the secondary winding and the heating element can be kept low. Particularly suitable as the upper limit of the induction frequency is 100 kHz since the range above 100 kHz comes close to the long-wavelength range of radios and an induction frequency above 100 kHz is associated with a high expenditure on interference suppression.

The expenditure on interference suppression can be kept low if the induction frequency generator is designed to produce a particularly pure sinusoidal vibration. The primary winding is hereby subjected to a voltage whose time profile substantially corresponds to a sine function. Such a voltage profile only has a small fraction of high-frequency harmonics which would need to be screened for the purposes of suppressing interference.

Appropriately, the heating element is design for operation up to 60 Volts. The advantage can be achieved that the secondary winding is only provided with a few winding loops and can thus be configured as small and light. In particular, small pots or jugs can be executed as low in weight without having to dispense with a high induction power.

Further advantages are obtained from the following description of the drawings, The drawings show one exemplary embodiment of the invention. The drawings, the description and the claims contain numerous features in combination. The person skilled in the art will appropriately consider the features individually or combine them to give logical further combinations. The same elements in the figures are provided with the same reference symbols.

In the figures:

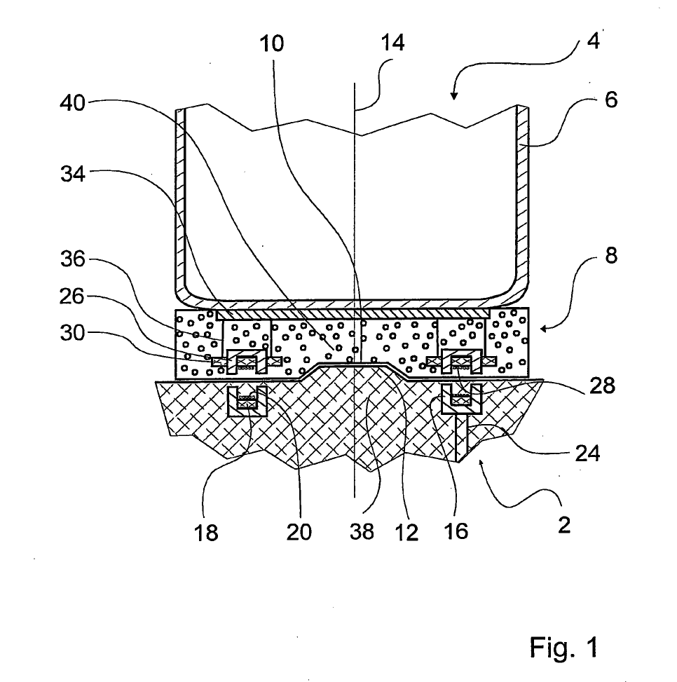

FIG. 1 is a sectional view through a device for heating food on a device for transmitting energy,

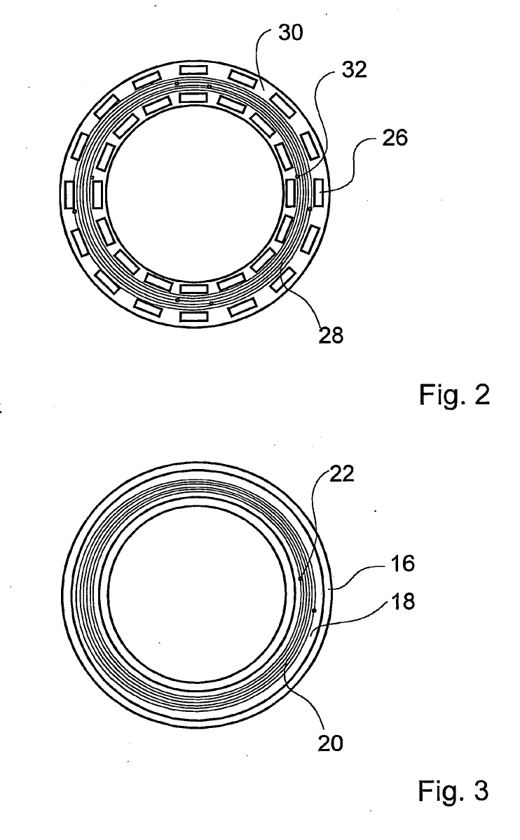

FIG. 2 is a view from below of secondary windings and winding cores of the device for heating food from FIG. 1,

FIG. 3 is a plan view of the primary winding and the winding core of the device for transmitting energy from FIG. 1,

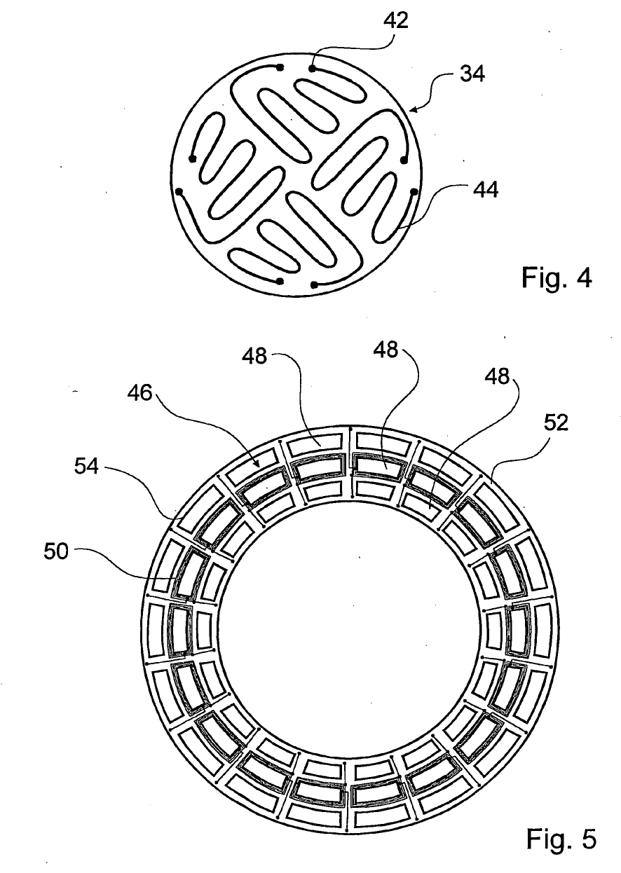

FIG. 4 is an arrangement of heating conductors of a heating element,

FIG. 5 is an arrangement of a plurality of E-shaped core elements each having a winding,

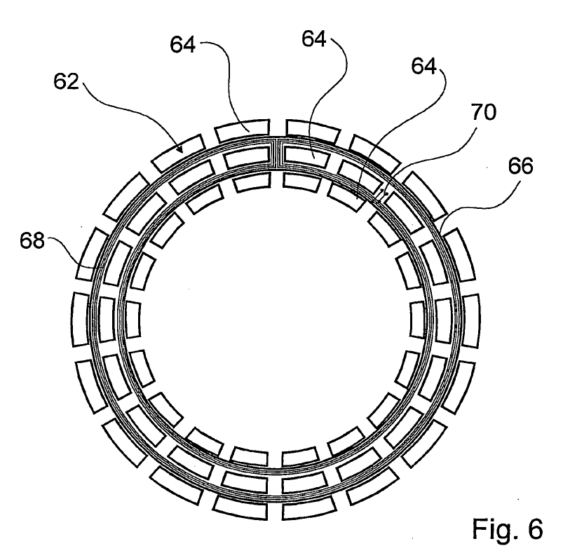

FIG. 6 is an arrangement of a plurality of E-shaped core elements having only one winding in total,

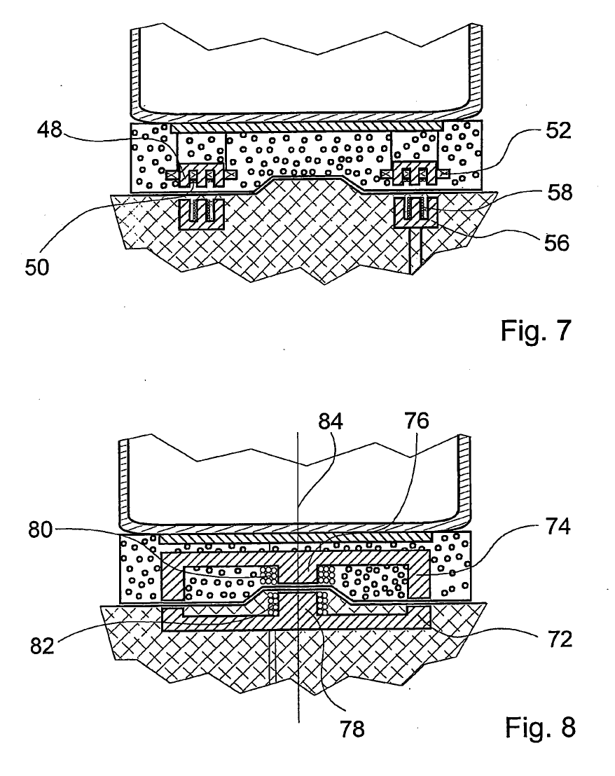

FIG. 7 is a sectional view through an arrangement of a plurality of E-shaped core elements and

FIG. 8 is a sectional view through an arrangement comprising two pot cores.

FIG. 1 shows a sectional view of a device 2 for transmitting energy which is configured as a hob. Located on the hob is a device 4 for heating food by means of induction in the form of an induction cooking pot which comprises a heating means 8 in the form of a base element underneath a pot-shaped steel container 6. The base element has a centrally arranged centring recess 10 which grips around a centring elevation 12 of the hob. The centring recess 10 and the centring elevation 12 are each configured as rotationally symmetrical about an axis of rotation 14.

Located in the hob is an annular winding core 16 which is shown in plan view in FIG. 3. In its cross-sectional profile the winding core 16 is configured as U-shaped in the radial direction. Its two annular side legs hold a printed circuit board 18. The printed circuit board 18 comprises a primary winding 29 which is integrated as a conductor path in the printed circuit board 18 and is shown schematically in FIG. 3 by means of circles. The primary winding 20 runs spirally between the two legs of the winding core 16 and is connected by means of two contact points 22 (FIG. 3) to two leads 24 which connect the primary winding 20 to a voltage source which is not shown.

The heating means 8 configured as base element exhibits the greatest extension in its horizontal directions. Both the primary winding 20 and also a secondary winding 28 are wound spirally so that the axis of rotation of the windings 20, 28 is located perpendicular to these directions of greatest extension. The induced magnetic flux is hereby guided specifically out from the hob and into the heating means 8.

The winding core 16 is configured as a pot core in the form of an annular core. In the case of smaller cores, the winding core 16 can be executed in a slight modification of its shape so that its inner circular wall or its inner leg is guided further inwards and to a column (FIG. 8) around which the primary winding is guided. Such an arrangement is particularly suitable for hobs provided for small devices for heating food.

A current passed through the primary winding 20 generates a magnetic flux which is guided through the two walls or legs of the winding core 16 to core elements 26 of a winding core 27 in the base element. The winding core 27 of the heating means 8 configured as base element comprises a total of 16 core elements 26 which are shown in FIG. 2 in a view of the base element from below where FIG. 2 does not show the entire base element but only the core elements 26, four secondary windings 28 and an annular printed circuit board 30 with contact points 32. The core elements 26 are each configured as having a U-shaped cross-section and are inserted with both their legs through recesses in the printed circuit board 30 through the printed circuit board 30. The core elements 26 are connected to the printed circuit board 30 by soldering or gluing.

The ends of the two legs of the core elements 26 are located at a distance of a few millimetres from the opposite ends of the two rotationally symmetrical legs of the winding core 16 in the hob. The magnetic flux induced by the primary winding 20 which is guided through the winding core 16 in the direction of the core elements 26 of the winding core 27 is hereby guided substantially completely through the core elements 26 of the winding core in the base element. As a result, a voltage is induced in the secondary windings 28 which can heat a heating element 34. The heating element 34 is connected to the four secondary windings 28 via leads 36 and the contact points 32 on the printed circuit board 30.

The winding core 16 is embedded in an impact-resistant plastic material 38 of the hob. The core elements 26 and the printed circuit board 30 are surrounded by a material 40 which is both heat-insulating and voltage-insulating. The thickness of the heat-insulating material 40 between the approximately 0.5 mm thick heating element 34 and the core elements 26 is 10 mm. As a result, the heat emitted by the heating element 34 is largely radiated back downwards so that the core elements 26 fabricated from a ferritic material cannot be heated above their optimal operating temperature of 100° C. to 120° C. even when the heating element 34 is heated to its maximum. The core elements 26 have a thickness in the axial direction parallel to the axis of rotation 14 of 10 mm. The winding core 16 configured as a pot core has a thickness of 15 mm in the axial direction.

The ferritic core elements 26 themselves generate heat as a result of substantially eddy current losses. This heat must be removed from the core elements 26 to prevent overheating of the core elements 26 in the surrounding heat-insulating material 40. By far the largest portion of this self-generated heat can be released downwards through the only thin layer of heat-insulating material 40 to the hob whose plastic material 38 has sufficient thermal conductivity to remove a sufficient heat current from the core elements 26 even at the maximum provided power consumption. In order to achieve good heat transfer from the base element into the hob, the base element and the hob are designed so that an air slit between the base element and the hob if possible over the entire area between base element and hob is less than 0.5 mm thick. The base element thus lies flat on the hob.

As a result of the annular configuration of the winding core 16 and the arrangement of the core elements 26 on a circular path, the magnetic flux is guided from the winding core 16 to the core elements 26 independently of the rotational position of the base element on the hob. The power loss in the winding core 16 and the core elements 26 is consequently independent of the rotational position with respect to one another. Each of the four secondary windings 28 has only the relatively small number of 20 winding loops. As a result even when the energy transfer from the primary winding 20 to the secondary winding 28 is the maximum provided, a voltage of less than 60 Volts is induced. In order to be able to apply a high heating power of up to 3000 W nevertheless, the primary winding 20 is connected to an induction frequency generator not shown which is designed to produce an induction frequency of 95 kHz. The quantity of transmitted power is controlled by controlling the amplitude of the voltage applied to the primary winding 20.

FIG. 4 shows the heating element 34 which comprises four heating conductors 44. The heating conductors 44 are each connected to one of the secondary windings 28 by means of respectively two contact points 42 and the leads 36. The heating element 34 can be configured in a fashion which seems appropriate to the person skilled in the art, for example, as a porcelain enamelled metal layer system (PEMS) which has an enamel layer approximately 250 μm thick applied to the outside of the base of the steel container 6. The heating conductors 44 are applied to the enamel layer as a thick layer paste using a screen printing method and then baked into the enamel. The heating conductors 44 have a thickness of about 250 μm. The heating conductors 44 are arranged in a circular area which can be thought of as divided into four piece—of-cake shaped segments. Located in each of these piece—of-cake shaped segments is one of the heating conductors 44 such that it is uniformly distributed in this segment. As a result, the entire heating element 34 is uniformly heated. The heating conductors 44 are arranged in the circular heating plane of the heating element 34: each two opposing heating conductors 44 are arranged in a point symmetry with respect to one another, the point of symmetry being located at the centre of the circular heating plane. As a result of the same type of configuration of the four heating conductors 44, the four secondary windings 28 and the 16 core elements 26, each of the four heating conductors 44 carries the same load. In addition to a uniform heat distribution, a long lifetime of the heating conductors 44 can also be achieved as a result.

FIG. 5 shows an alternative arrangement of 18 core elements 46. The core elements 46 are each configured as E-shaped (FIG. 7) and have three webs 48 arranged on a base disposed transverse to the radial direction, of which the central web 48 is each embraced by a winding 50. These secondary windings 50 are formed on a printed circuit board 52 as spiral conductor paths expanding from inside to outside. The core elements 46 are each inserted with their three webs 48 through openings 54 in the printed circuit board and are held in position by the printed circuit board 52. The winding core arranged on the opposite side, shown as the primary side in FIG. 7, also comprises 18 core elements 56 which are formed substantially the same as the core elements 46 of the secondary winding apart from a greater web height. However, these core elements 56 of the primary side are not held by a printed circuit board but by a retaining device which is not shown. Placed around the central web of the core elements 56 on the primary side is respectively one winding 58 which is held by a winding retaining device also not shown.

The core elements 46 and 56 are configured as circular-ring-segment-shaped. The arrangement of the core elements 46, 56 can be modified such that substantially no air remains between the circular-ring-shaped segments 46, 56. In this case, the radially outermost webs 48 of the core elements 46, 56 are arranged directly adjacent to one another. The central webs 48 each have an intermediate space between them in which the windings 50, 58 are located. The radially innermost of the three webs 48 are so close to one another that the leads 60 just fit between these webs 48. The core elements 46, 56 in their entirety thus form a substantially annular core formed from a plurality of contiguous or almost contiguous core elements 46, 56. The angle segment covered by each of the core elements 46, 56 can be matched to the power which is to be transferred by each of the core elements 46, 56. As a result of the small spacing of the core elements 46, 56 from one another, energy transfer can take place largely independently of the relative rotational position of one pot and a hob with respect to each other.

The leads 60 connect the windings 50 to respectively one heating conductor so that a heating conductor of a heating element is allocated to each winding 50. Alternatively, the leads 60 can be connected to only one single heating conductor which carries the entire heat load.

Another exemplary embodiment is shown in FIG. 6. The core elements shown 62 corresponds to the core elements 46 from FIG. 5. The outer webs 64 embrace a printed circuit board 66 which is arranged completely inside the core elements 62 and is firmly connected thereto. The central webs of the respectively three webs 64 are inserted through an opening of the printed circuit board 66 and are completely embraced by a winding 68 which is guided several times around all the central webs 64 in forward circle and a backward circle. From the winding 68 two leads 70 lead to a heating element, not shown, which carries the entire heat load.

FIG. 8 shows an arrangement of two winding cores 72 configured as pot cores, having respectively one winding 80, 82 guided around their central columns 76, 78. The winding cores 72, 74 are rotationally symmetrical about an axis 84. The winding cores each have an annular side wall 86, 88 likewise rotationally symmetrical about this axis 84. Central columns 76, 78 have an axial height, that is an extension in the direction of the axis 84, which differs from the axial height of the respectively pertinent side walls 86, 88. The axial height of the central column 78 of the winding core 72 is less than the axial height of the side wall 86 of the winding core 72. At the winding core 74 the situation is different and the axial height of the central column 76 is less than the axial height of the side wall 88. In this way, the gap between the winding cores 72, 74 can be kept uniformly small both in the area of a centring elevation 90 and also in the outer areas at the side walls 86, 88.

The use of a winding core can depend on the size of the pot. For example, if a winding core has a radius of less than 5 cm, a one-piece winding core, for example, a pot or ring core can be selected and if a radius is greater than 5 cm, a winding core consisting of a plurality of core elements can be selected. Especially in the case of large winding cores, it is also possible to execute the winding core in the base element and the winding core in the hob as composed of a plurality of core elements. In this case, the winding cores should be configured as far as possible with respect to one another so that power transmission is independent of the rotational position of the cores relative to one another. The thickness of a winding core is advantageously, depending on its radius, between 5 mm and 30 mm, appropriately between 8 mm and 20 mm with a pot core between 10 mm and 30 mm thick and core elements between 5 mm and 15 mm thick. The thickness of the insulation layer between winding core and heating element is appropriately selected between 5 and 30 mm, especially between 8 mm and 20 mm.

The configurations of the windings 20, 28, 50 and winding cores 16, core elements 26, 46 and printed circuit boards 18, 30, 52 and the primary side and secondary side in association with one another shown in the figures can also be combined in another fashion which seems appropriate to the person skilled in the art. All possible combinations which not shown here for the sake of clarity, are herewith to be considered as shown in the figures.

### REFERENCE LIST

2 Device
4 Device
6 Steel container
8 Heating means
10 Centring recess
12 Centring elevation
14 Axis of rotation
16 Winding core
18 Printed circuit board
20 Winding
22 Contact point
24 Lead
26 Core element
27 Winding core
28 Winding
30 Printed circuit board
32 Contact point
34 Heating element
36 Lead
38 Plastic material
40 Material
42 Contact point
44 Heating conductor
46 Core element
48 Web
50 Winding
52 Printed circuit board
54 Opening
56 Core element
58 Winding
60 Lead
62 Core element
64 Web
66 Printed circuit board
68 Winding
70 Lead
72 Winding core
74 Winding core
76 Central column
78 Central column
80 Winding
82 Winding
84 Axis
86 Side wall
88 Side wall
90 Centring elevation

1-17. (canceled)

18. A device for heating food by means of induction, comprising:
heating means including a secondary winding formed from a current conductor and a heating element connected to said winding; and
a winding core disposed inside said secondary winding.

19. The device according to claim 18, including said winding core configured as substantially rotationally symmetrical.

20. The device according to claim 18, including said winding core configured as a pot core.

21. The device according to claim 20, including said winding includes a central column having a first axial height and an annular side wall having a second axial height different from said first axial height.

22. The device according to claim 18, including said winding core includes a plurality of core elements.

23. The device according to claim 22, including said core elements arranged on a substantially circular path and configured substantially as circular-ring-segment-shaped.

24. The device according to claim 23, including said core elements formed substantially U-shaped in one radial cross-section.

25. The device according to claim 23, including said core elements formed substantially E-shaped in one radial cross-section.

26. The device according to claim 22, including retaining means which interconnect said core elements in a load-bearing manner.

27. The device according to claim 26, including said retaining means include a printed circuit board.

28. The device according to claim 26, including said retaining means configured as substantially ring-shaped.

29. The device according to claim 18, including said winding arranged on a printed circuit board.

30. The device according to claim 18, including said winding arranged as substantially spiral-shaped.

31. The device according to claim 18, including said heating element includes the same number of substantially identical heating conductors as the winding core has core elements.

32. The device according to claim 31, including at least two heating conductors are arranged substantially symmetrically with respect to one another and especially in a substantially circular heating area.

33. The device according to claim 31, including said heating conductors arranged in a substantially circular heating area and each said heating conductor arranged substantially uniformly distributed in a piece-of-cake-shaped segment.

34. A device for transmitting energy to a device for heating food by means of induction, comprising:
a primary winding formed from a current conductor and connected to a voltage source; and
a winding core located inside said primary winding.

35. The device according to claim 34, including said winding core configured as substantially rotationally symmetrical.

36. The device according to claim 34, including said winding core configured as a pot core.

37. The device according to claim 36, including said winding includes a central column having a first axial height and an annular side wall having a second axial height different from said first axial height.

38. The device according to claim 34, including said winding core includes a plurality of core elements.

39. The device according to claim 38, including said core elements arranged on a substantially circular path and configured substantially as circular-ring-segment-shaped.

40. The device according to claim 38, including said core elements formed substantially U-shaped in one radial cross-section.

41. The device according to claim 38, including said core elements formed substantially E-shaped in one radial cross-section.

42. The device according to claim 38, including retaining means which interconnect said core elements in a load-bearing manner.

43. The device according to claim 42, including said retaining means include a printed circuit board.

44. The device according to claim 42, including said retaining means configured as substantially ring-shaped.

45. The device according to claim 34, including said winding arranged on a printed circuit board.

46. The device according to claim 34, including said winding arranged as substantially spiral-shaped.

47. The device according to claim 34, including said heating element includes the same number of substantially identical heating conductors as the winding core has core elements.

48. The device according to claim 47, including at least two heating conductors are arranged substantially symmetrically with respect to one another and especially in a substantially circular heating area.

49. The device according to claim 47, including said heating conductors arranged in a substantially circular heating area and each said heating conductor arranged substantially uniformly distributed in a piece-of-cake-shaped segment.
